(19) United States
(12) Patent Application Publication
(10) Pub. No.: US 2014/0281373 A1
(43) Pub. Date: Sep. 18, 2014

(54) DIGITAL SIGNAL PROCESSOR AND BASEBAND COMMUNICATION DEVICE

(71) Applicant: MediaTek Sweden AB, Linköping (SE)

(72) Inventor: Anders Nilsson, Linkoping (SE)

(73) Assignee: MediaTek Sweden AB, Linköping (SE)

(21) Appl. No.: 14/350,541

(22) PCT Filed: Sep. 17, 2012
(86) PCT No.: PCT/SE2012/050980

§ 371 Date: Apr. 8, 2014

(30) Foreign Application Priority Data
Oct. 18, 2011 (SE) 1150967-6

(51) Int. Cl. G06F 9/30

(52) U.S. Cl. CPC G06F 9/30036
USPC 712/7

(57) ABSTRACT

A digital signal processor has a vector execution unit arranged to execute instructions on multiple data in the form of a vector, comprising a local queue arranged to receive instructions from a program memory and to hold them in the local queue until a predefined condition is fulfilled. The local queue being arranged to receive a sequence of instructions at a time from the program memory and to store the last N instructions, N being an integer. A vector controller in the vector execution unit comprises queue control means arranged to make the local queue repeat a sequence of M instructions stored in the local queue, M being an integer less than or equal to N, a number K of times. This reduces the time the vector execution unit is kept waiting because of IDLE commands in the program memory.

### TECHNICAL FIELD

The present invention relates to a SIMT-based digital signal processor.

### BACKGROUND AND RELATED ART

Many mobile communication devices use a radio transceiver that includes one or more digital signal processors (DSP).

Many of the functions frequently performed in such processors are performed on large numbers of data samples. Therefore a type of processor known as Single Instruction Multiple Data (SIMD) processor is useful because it enables one single instruction to operate on multiple data items rather than on one integer at a time. This kind of processor is able to process vector instructions, which means that a single instruction performs the same function to a number of data units. Therefore, they may be referred to as vector execution units. Data are grouped into bytes or words and packed into a vector to be operated on.

As a further development of SIMD architecture, the Single Instruction stream Multiple Tasks (SIMT) architecture has been developed. Traditionally in the SIMT architecture one or two SIMD type vector execution units have been provided in association with an integer execution unit which may be part of a core processor.

International Patent Application WO 2007018467 discloses a DSP according to the SIMT architecture, having a processor core including an integer processor and a program memory, and two vector execution units which are connected to, but not integrated in the core. The vector execution units may be Complex Arithmetic Logic Units (CALU) or Complex Multiply-Accumulate Units (CMAC). The core has a program memory for distributing instructions to the execution units. In WO2007018467 each of the vector execution units has a separate instruction decoder. This enables the use of the vector execution units independently of each other, and of other parts of the processor, in an efficient way.

In a SIMT architecture therefore, there are several execution units. Normally, one instruction may be issued from program memory to one of the execution units every clock cycle. Since vector operations typically operate on large vectors, an instruction received in one vector execution unit during one clock cycle will take a number of clock cycles to be processed. In the following clock cycles, therefore, instructions may be issued to other computing units of the processor. Since vector instructions run on long vectors, many RISC instructions may be executed during the vector operation.

Many baseband algorithms may be decomposed into chains of smaller baseband tasks with little backward dependencies between tasks. This property may not only allow different tasks to be performed in parallel on vector execution units, it may also be exploited using the above instruction set architecture.

Often, to provide control flow synchronization and to control the data flow, “idle” instructions may be used to halt the control flow until a given vector operation is completed. The “idle” instruction will halt further instruction fetching until a particular condition is fulfilled. Such condition can be the completion of a vector instruction in a vector execution unit.

Typically a DSP task will comprise a sequence of two or three instructions, as will be discussed in more detail later. This means that the vector execution unit will receive a vector instruction, say, to perform a calculation, and execute it on the data vector provided until it is done with the entire vector. The next instruction will be to process the result and store it in memory, which can theoretically happen immediately after the calculation has been performed on the whole vector. Often, however, a vector execution unit has to wait several clock cycles for its next instruction from the program memory as the processor core is busy waiting for other vector units to complete, which leads to inefficient utilization of the vector execution unit. This probability that a vector execution unit is kept inactive increases with the increasing number of vector execution units.

### SUMMARY OF THE INVENTION

Co-pending patent application entitled Digital Signal Processor and Baseband Communication Device and filed by the same applicant on the same day as the present application relates to enhancing the degree of parallelism in such a processor. This is solved according to the co-pending application by providing a local queue in each vector execution unit. The local queue of a particular vector execution unit is able to store a number of commands intended for this vector execution unit and feed them to the vector execution unit independently of the state of the program memory.

Hence, the processing according to this co-pending application is made more efficient by increasing the parallelism in the processor. The invention is based on the insight that in the prior art a vector execution unit which has finished a vector instruction often cannot receive the next instruction immediately. This will happen when a vector execution unit is ready to receive a new command while the first command in the program memory is intended for another vector execution unit which is busy. In this case, no vector execution unit can receive a new command until the other vector execution unit is ready to receive its next command. Because of the local queue provided for each vector unit, a bundle of instructions comprising several instructions for one vector unit can be dispatched to the vector unit at one time. The SYNC instruction pauses the reading of instructions from the local queue, until a condition is fulfilled, typically that the data path is ready to receive and execute another instruction. These two features together enable a sequence of instructions to be sent to the vector execution unit at once, stored in the local queue and be processed in sequence in the vector execution unit so that as soon as the vector execution unit is done with one instruction it can start on the next. In this way each vector execution unit can work with a minimum of inactive time.

It is an objective of the present invention to make the internal communication within the processor as efficient as possible.

This objective is achieved according to the present invention by a vector execution unit for use in a digital signal processor, said vector execution unit being arranged to execute instructions, including vector instructions that are to be performed on multiple data in the form of a vector, comprising

A vector control unit a vector controller arranged to determine if an instruction is a vector instruction and, if it is, inform a count register arranged to hold the vector length, said vector controller being further arranged and control the execution of instructions, wherein said vector execution unit comprises
a local queue arranged to receive at least a first and a second instruction from a program memory and to hold the second instruction in the local queue until a predefined condition is fulfilled,
the local queue being arranged to receive a sequence of instructions at a time from the program memory and to store the last N instructions, N being an integer,
wherein the vector controller comprises queue control means arranged to control the local queue in such a way as to repeat a sequence of M instructions stored in the local queue, M being an integer less than or equal to N, a number K of times.

Preferably, the vector controller controls the execution of instructions on the basis of an issue signal received from the core. Alternatively, the issue signal may be handled locally by the vector execution unit itself.

The queue control means preferably comprises
a buffer manager arranged to keep track of the M instructions that are to be repeated, and the number K of times an instruction should be repeated, M and K being integers.
a iteration control means arranged to monitor the repeated execution of a sequence of instructions to determine when the iteration of the execution should be stopped,
an instructions count register arranged to hold the number M of instructions that are to be repeated and their position in the queue.

According to the invention a local queue is arranged in the form of, for example, a cyclic buffer arranged to store the last N instructions, N being an integer. Any suitable integer may be arranged, for example 16. The vector execution unit then has a repeat instruction arranged to repeat the last M instructions in the queue a number K of times, M and K also being suitable integers. K may be retrieved from the control register file, from the instruction word or from some other source. In this case the vector execution unit also comprises an iteration counter that will count the number of iterations up to K. The repeat function is arranged to decrement (or increments) the iteration counter K times before stopping the iteration of the instruction.

According to the present invention, bandwidth is saved in the control path since the same set of instructions can be sent from program memory once and performed in the vector execution unit a number of times. This is in contrast to prior art solutions where an instruction loop is achieved by sending the same sequence of instructions from the program memory each time it is to be executed. Especially for high numbers of K this is clearly advantageous.

The buffer manager may be arranged to retrieve the integer K from the control register file, or from the instruction word itself.

In a preferred embodiment the iteration control means is a counter arranged to keep track of the K iterations.

The processor according to embodiments of this invention are particularly useful for Digital Signal Processors, especially baseband processors.

Hence, the invention also relates to a digital signal processor comprising:
A processor core including an integer execution unit configured to execute integer instructions; and
At least a first and a second vector execution unit separate from and coupled to the processor core, wherein each vector execution unit is a vector execution unit according to any one of the preceding claims;

Said digital signal processor comprising a program memory arranged to hold instructions for the first and second vector execution unit and issue logic for issuing instructions, including vector instructions, to the first and second vector execution unit.

The program memory may be arranged in the processor core and may also be arranged to hold instructions for the integer execution unit.

The invention also relates to a baseband communication device suitable for multimode wired and wireless communication, comprising:
A front-end unit configured to transmit and/or receive communication signals;
A programmable digital signal processor coupled to the analog front-end unit, wherein the programmable digital signal processor is a digital signal processor according to the above.

In a preferred embodiment, the vector execution units referred to throughout this document are SIMD type vector execution units or programmable co-processors arranged to operate on vectors of data.

The processor according to embodiments of this invention are particularly useful for Digital Signal Processors, especially baseband processors. The front-end unit may be an analog front-end unit arranged to transmit and/or receive radio frequency or baseband signals.

Such processors are widely used in different types of communication device, such as mobile telephones, TV receivers and cable modems. Accordingly, the baseband communication device may be arranged for communication in a wireless communications network, for example as a mobile telephone or a mobile data communications device. The baseband communication device may also be arranged for communication according to other wireless standards, such as Bluetooth or WiFi. It may also be a television receiver, a cable modem, WiFI modem or any other type of communication device that is able to deliver a baseband signal to its processor. It should be understood that the term “baseband” only refers to the signal handled internally in the processor. The communication signals actually received and/or transmitted may be any suitable type of communication signals, received on wired or wireless connections. The communication signals are converted by a front-end unit of the device to a baseband signal, in a suitable way.

### BRIEF DESCRIPTION OF THE DRAWINGS

In the following the invention will be described in more detail, by way of example, and with reference to the appended drawings.

FIG. 1 is a block diagram of the baseband processor according to an embodiment of the invention.

FIG. 2 is a diagram illustrating the instruction issue pipelines of one embodiment of the processor core of FIG. 1.

FIG. 3 illustrates the instruction issue logic in SIMT processors

FIG. 4 illustrates a Vector execution unit according to the prior art

FIG. 5 illustrates a Vector execution unit including vector execution units having local queues

FIG. 6 illustrates a Vector execution unit according to a general embodiment of the invention in which there is a local queue

FIG. 7 illustrates a local queue according to the present invention.

### DETAILED DESCRIPTION OF EMBODIMENTS

FIG. 1 is a block diagram of a baseband processor, PBBP, 500 according to an embodiment of the invention. PBBP 500 includes a processor core which includes a RISC-type execution unit, and which is represented by RISC data path 510. PBBP further has a number of vector execution units 520, 530 each including a vector control unit 275 respectively and a SIMD datapath 525, 535, respectively. As is common in the art, each datapath 525, 535 may comprise several datapaths. Typically, for example, datapath 525 has four parallel CMAC datapaths which together constitute the datapath 525.

To provide control over the multiple vector execution units, the core hardware 500 includes a program flow control unit 501 coupled to a program counter 502 which is in turn coupled to program memory (PM) 503. PM 503 is coupled to multiplexer 504, unit-field extraction 508. Multiplexer 504 is coupled to instruction register 505, which is coupled to instruction decoder 506. Instruction decoder 506 is further coupled to control signal register (CSR) 507, which is in turn coupled to the remainder of the RISC datapath 510.

Similarly, each of the vector execution units 520 and 530 are also arranged to receive instructions from the program memory 503 located in the core. The vector execution units include respective vector length registers 521, 531 instruction registers 522, 532, instruction decoders 523, 533, and CSRs 524, 534, which are coupled to their respective data paths 525 and 535. These units and their functions will be discussed in more detail, insofar as they are relevant to the invention, in connection with FIG. 3.

FIG. 2 is an example of prior art handling of instructions from the program memory to the various execution units, intended as an illustration of the underlying problem of the invention. The left column of FIG. 2 represents time (in execution clock cycles). The remaining columns represent, from left to right, the execution pipelines of a first and a second vector execution unit (more specifically, the datapaths of CMAC 203 and CALU 205) and the integer execution unit and the issuance of instructions thereto. More particularly, in the first clock cycle, a complex vector instruction (e.g., CMAC.256) is issued to CMAC 203. As shown, the vector instruction takes many cycles to complete. In the next clock cycle, a vector instruction is issued to CALU 205. In the next clock cycle, an integer instruction is issued to integer execution unit 510. In the next several cycles, while the vector instructions are being executed, any number of integer instructions may be issued to integer execution unit 510. It is noted that although not shown, the remaining vector execution units may also be concurrently executing instructions in a similar fashion.

In some cases an “idle” instruction may be included in the sequence of instructions, to stop the core program flow controller from fetching instructions from the program memory. For example, to synchronize the program flow to the completion of a vector instruction, the “idle” instruction may be used to suspend the fetching of instructions until a certain condition have been met. Typically, this condition will be that the vector execution unit concerned is done with a previous vector instruction and is able to receive a new instruction. In this case, the vector controller 275 of the vector execution unit 520, 530 concerned will send an indication, such as a flag, to the program flow controller 501 indicating that the vector execution unit is ready to receive another instruction.

Idle instructions may be used for more than one vector execution unit at the same time. In this case, no further instructions may be sent from the program memory 503 until each of the vector execution units 520, 530 concerned has sent a flag indicating that it is ready to receive a new instruction.

In the example in FIG. 2, the “idle” instruction is issued after the integer instructions mentioned above. The idle instruction is used in this example to halt the control flow until the vector operation performed by the CMAC 203 is completed.

The following example will be discussed on the basis of a SIMT DSP with an arbitrary number of execution units. For simplicity, all units are assumed in this example to be CMAC vector execution units, but in practice units of different types will be mixed and used together.

In many base band processing algorithms and programs, the algorithm can be decomposed into a number of DSP tasks, each consisting of a “prolog”, a vector operation and an “epilog”. The prolog is mainly used to clear accumulators, set up addressing modes and pointers and similar, before the vector operation can be performed. When the vector operation has completed, the result of the vector operation may be further processed by code in the “epilog” part of the task. In SIMT processors, typically only one vector instruction is needed to perform the vector operation.

The typical layout of one DSP task is exemplified by the following example task according to prior art:

The code snippet in the example performs a complex dot-product calculation over 512 complex values and then store the result to memory again. The routine requires the following instructions to be fetched by the processor core.

| .cmac0 | ;Assume cmac0 is selected | |
|---|---|---|
| prolog: | ;Address setup | |
| | ldi #0, r0 | |
| | out r0, cdm0_addr | |
| | out r0, cdm1_addr | |
| | out r0, cdm2_addr | |
| | setcmvl.512 | ; Set vector length to 512 |
| vectorop: | cmac [0],[1],[2] | ; Perform cmac operation over <vector |
| | | length> |
| | | ; samples |
| | idle #cmac0 | ; Stop program fetching until cmac0 is |
| | | ready |
| epilog: | star [3] | ; Store accumulator |

In the example above, the setcmvl, cmac and star instructions are issued to and executed on the CMAC vector execution unit whereas ldi, out and idle instructions are executed on the integer core (“core”).

The vector length of the vector instructions indicates on how many data words (samples) the vector execution unit should operate on. The vector length may be set in any suitable way, for example one of the following:
1) By dedicated instructions, such as setcmvl.123 in the example above
2) Carried in the instruction itself, for example according to the format: cmac.123, as shown in FIG. 2.
3) Set by a control register, for example according to the format out r0, cmac_vector_length

The instruction idle #cmac0 instructs the core program flow controller to stop fetching new instructions until the CMAC0 unit has finished its vector operation. After the idle function releases, and allowing new instructions to be fetched, the “star” instruction is fetched and dispatched to the CMAC0 vector execution unit. The star instruction instructs the CMAC vector execution unit to store the accumulator to memory.

In the next example, also illustrating prior art, two vector execution units are used. The instruction sequence related to the first vector execution unit is the same as above:

| | |
|---|---|
| .cmac0 | ;Assume cmac0 is selected |
| prolog: | ;Address setup |

| ldi #0, r0 | |
|---|---|
| out r0, cdm0_addr | |
| out r0, cdm1_addr | |
| out r0, cdm2_addr | |
| setcmvl.512 | ; Set vector length to 512 |

| | | |
|---|---|---|
| vectorop: | cmac [0],[1],[2] | ; Perform cmac operation over <vector |
| | | length> |
| | | ; samples |

| | |
|---|---|
| idle #cmac0 | ; Stop program fetching until cmac0 is |

| | | ready |
|---|---|---|
| epilog: | star [3] | ; Store accumulator |

The instruction sequence related to the second vector execution unit is:

| .cmac1 | ;Assume cmac1 is selected | |
|---|---|---|
| prolog: | ;Address setup | |
| | ldi #0, r0 | |
| | out r0, cdm3_addr | |
| | out r0, cdm4_addr | |
| | out r0, cdm5_addr | |
| | setcmvl.2048 | ; Set vector length to 2048 |
| vectorop: | cmac [0],[1],[2] | ; Perform cmac operation over <vector |
| | | length> |
| | | ; samples |
| | idle #cmac1 | ; Stop program fetching until cmac0 is |
| | | ready |

| | | |
|---|---|---|
| epilog: | star [3] | ; Store accumulator |

In this case, the second vector execution unit is instructed to perform a vector operation of length 2048, which will take 4 times as long as the operation of length 512 in the first vector execution unit. The first vector execution unit will therefore finish before the second vector execution unit. Since the program memory is instructed, by the instruction Idle #cmac1 to hold the next instruction until the second vector execution unit is finished, it will also not be able to send a new instruction to the first vector execution unit until the second vector execution unit is finished. The first vector execution unit will therefore be inactive for more than 1000 clock cycles because of the idle instruction related to the second vector execution unit.

The above example uses two vector execution units. As will be understood, this will be a bigger problem the higher the number of vector execution units, since an idle instruction related to one particular vector execution unit will potentially affect a higher number of other vector execution units. According to the invention this problem is reduced by providing a local queue for each vector execution unit. The local queue is arranged to receive from the program memory in the processor core one or more instructions for its vector execution unit to be executed consecutively, and to forward one instruction at a time to the vector execution.

At the same time, a command is introduced, which instructs the local queue to hold the next instruction until a particular condition is fulfilled. The condition may be, for example that the vector execution unit is finished with the previous command or that the data path is ready to receive a new instruction. For the sake of simplicity, in this document, this new command is referred to as SYNC. The condition may be stated in the instruction word to the SYNC instruction, or it may be read from the control register file or from some other source.

An example of a sequence of instructions using the new SYNC command is given in the following:

| .cmac0 | ;Select cmac0 as destination for cmac related instructions | |
|---|---|---|
| | ;Address setup | |
| | ldi #0, r0 | |
| | out r0, cdm0_addr | |
| | out r0, cdm1_addr | |
| | out r0, cdm2_addr | |
| | setcmvl.512 | ; Set vector length to 512 |
| | cmac [0],[1],[2] | ; Perform cmac operation over 512 samples |
| | sync | ; Stop program queue until cmac is ready |
| | star [3] | ; Store accumulator |
| .cmac1 | ;Select cmac1 as destination for cmac related instructions | |
| | ;Address setup | |
| | ldi #0, r0 | |
| | out r0, cdm3_addr | |
| | out r0, cdm4_addr | |
| | out r0, cdm5_addr | |
| | setcmvl.2048 | ; Set vector length to 2048 |
| | cmac [0],[1],[2] | ; Perform cmac operation over 2048 samples |
| | sync | ; Stop program queue until cmac is ready |
| | star [3] | ; Store accumulator |

In contrast to the prior art, each of these two sequences of commands may be sent to the local queue of the vector execution unit concerned in one go and stored there while waiting to be sent one command at the time to the instruction decoder within the vector execution unit. As explained above, the command sync is provided to halt the local queue until the vector execution unit is finished with the command cmac, which is a vector instruction and therefore takes several clock cycles to perform.

FIG. 3 illustrates the instruction issue logic in a prior art baseband processor 700 that may be used as a starting point for the present invention. The baseband processor comprises a RISC core 701 having a program memory PM 702 holding instructions for the various execution units of the processor, and a RISC program flow control unit 703. From the program memory 702, instructions are fetched to an issue logic unit 705, which is common to all execution units and arranged to control where to send each specific instruction. The issue logic 705 corresponds to the units Unit-field extraction 508 and issue control 509 of FIG. 1 The issue logic is connected in this case to a number of vector execution units 710, 712, 714 and through a multiplexer 715 to a RISC core +datapath unit 716, the latter being part of the RISC core and corresponding to the units 505, 506, 507 and 510 of FIG. 1. As explained above, in one embodiment the instruction words, comprising the actual instructions, are sent to all execution units, whereas the issue signal corresponding to a particular instruction is sent only to the execution unit that is to execute this instruction. In an alternative embodiment the issue signal is handled locally by each vector execution unit.

FIG. 4 illustrates a vector execution unit 710, which may be one of the vector execution units 710, 712, 714 of FIG. 3, according to the prior art. The vector execution unit 710 has a vector controller 720, a vector length counter 721, an instruction register 722 and an instruction decoding unit 723. As in FIG. 3 the vector execution unit 710 of FIG. 4 receives instructions from the program memory 702, although FIG. 4 has been simplified. The instruction word is the actual instruction and is received in the instruction register 722 and forwarded to the instruction decoder 723. The issue signal is received in the vector controller via the issue logic unit 705 and used to control the execution of the instruction word. If the issue signal is active the instruction is loaded into the instruction register, decoded and executed, otherwise it is discarded. The vector controller 720 also manages the vector length counter 721 and other control signals used in the system as will be discussed below.

Traditionally, during each clock cycle, one instruction intended for one of the execution units, may be fetched from the program memory 702. The unit field in the instruction word may be extracted from the instruction word and used to control to which control unit the instruction is dispatched. For example, if the unit field is “000” the instruction may be dispatched to the RISC data-path. This may cause the issue logic 705 to allow the instruction word to pass through multiplexer 715 into the RISC core 716 (not shown in FIG. 4), while no new instructions are loaded into the vector execution units this cycle. If however, the unit field held any other value, the issue logic 705 may enable the corresponding instruction issue signal to the vector execution unit for which it is intended. Then the vector controller 720 in the selected vector execution unit lets the instruction word to pass through into the instruction register 722 of said vector execution unit. In that case, a NOP instruction will be sent to the RISC data path instruction register in the RISC core 716.

To handle vector instructions, when an instruction is dispatched to the vector execution units, the vector length field from the instruction word may be extracted and stored in the count register 721. This count register may be used to keep track of the vector length in the corresponding vector instruction, and when to send the flag indicating that the vector execution unit is ready to receive another instruction. When a corresponding vector execution unit has finished the vector operation, the vector controller 720 may cause a signal (flag) to be sent to program flow control 703 (not shown in FIG. 4) to indicate that the unit is ready to accept a new instruction. The vector controller 720 of each vector execution unit 520, 530 (see FIG. 1) may additionally create control signals for prolog and epilog states within the execution unit. Such control signals may control VLU and VSU for vector operations and also manage odd vector lengths, for example.

When the issue logic 705 determines, by decoding the unit field, that a particular instruction should be sent to a particular vector execution unit, the instruction word is loaded from the program memory 702 into the instruction register 722. Also, if the instruction is determined (by the vector controller) to carry a vector length field, the count register 721 is loaded with this value the vector length value. The vector controller 720 decodes parts of the instruction word to determine if the instruction is a vector instruction and carries vector length information. If it is, the vector controller 720 activates a signal for the count register 721 to load a value indicating the vector length into the count register 721. The vector controller 720 also instructs the instruction decoder unit 723 to start decode the instruction and start sending control signals to the datapath 724. The instruction in the instruction register 722 is then decoded by the instruction decoder 723, whose control signals are kept in the control signal register 724 before they are sent to the datapath. The count register 721 keeps track of the number of times the instruction should be repeated, that is the vector length, in a conventional way.

FIG. 5 illustrates a vector execution unit 810 according to the invention. The vector execution unit comprises all the elements of the prior art vector execution unit shown in FIG. 4 denoted by the same reference numerals. In addition, the vector execution unit according to the invention has a local queue 730 arranged to hold a number of instructions received from the program memory. A queue controller 732 arranged to control the local queue 730 is arranged in the vector control unit 720. The queue 730 and the queue controller 732 are connected to each other to exchange information and commands. For example, the queue controller 732 may comprise a counter arranged to keep track of the number of instructions in the queue 730. Alternatively, the queue itself may keep track of its status and send information indicating that it is full, or empty, or nearly full or empty, to the queue controller 732. Hence, the queue controller 732 holds status information about the local queue 730 and may send control signals to start, halt or empty the local queue 730. The instruction decoder 723 is arranged to inform the vector controller 730 about which instruction is presently being executed.

As explained above, many DSP tasks are implemented as a sequence of instructions, for example a prolog, a vector instruction and an epilog. The vector instructions will run for a number of clock cycles during which time no new command may be fetched. In this case, as explained above, the new SYNC instruction is used to make the local queue hold the next instruction until a particular condition is met. When the queue controller 732 is informed that the instruction decoder 723 has decoded a “sync” instruction, it will set a mode in the queue controller 732 stopping the local queue 730 until the condition is fulfilled. This is normally implemented using the remaining vector length information and information about the current instruction from the instruction decoder. Flags that are sent from the data path 724 to the queue controller 732 can also be used. Typically the condition will be that the processing of the vector instruction is finished so that the instruction decoder 723 in the vector execution unit is ready to process the next instruction.

The local queue 730 could be any kind of queue suitable for holding the desired number of instructions. In one it is a FIFO queue able to hold an appropriate number, for example, 8 instructions.

FIG. 6 illustrates a vector execution unit 910 according to a preferred embodiment of the invention. The vector execution unit shown in FIG. 6 comprises the same units as in FIG. 5, interconnected in the same way. In this embodiment, however, the local queue 730 is a cyclic queue suitable for repeating a specified number of instructions. This will be particularly advantageous in implementations where the same sequence of instructions is to be executed a large number of times. The number of times can sometimes exceed 1000. In this case a significant amount of bandwidth can be saved in the control path by not having to send the same instructions from the core unit to the vector execution unit again each time they are to be executed.

As in FIG. 5 there is a queue controller 732 arranged in the vector controller 720. In the embodiment of FIG. 6 there is also a buffer manager 744 arranged to keep track of the instructions that are to be repeated, and the number of times an instruction should be repeated. For this purpose there are two registers, which are also controlled by the vector controller 720: a repetition register 746 for storing the number of repetitions of the instruction and an instruction count register 748 arranged to hold the number of instructions that are to be repeated.

As all instructions issued to the vector execution unit pass the queue 730, that is, the cyclic buffer, the buffer will remember the last N (typically 8-16) instructions.

The repetition register 746 is configured to hold the number of repetitions to be executed. The repetition register 746 can be loaded by the control register file or be read from the instruction word issued to the vector execution unit or by any other method.

The instruction count register 748 is configured to hold the number indicating how many instructions in the cyclic buffer 730 that should be included in the repeat loop. The instruction count register can be loaded by the control register file or be read from the instruction word issued to the vector execution unit or by any other method.

When a “repeat” instruction, or an instruction with a “repeat flag” set is issued to the vector execution unit, the instruction decoder 723 in conjunction with the vector controller 720 instructs the queue controller 732 to dispatch instructions from the cyclic buffer 730 to the instruction register 722.

As in FIG. 5, when a “sync” instruction is encountered by the instruction decoder 723, the instruction decoder instructs the queue controller 732 to stop fetching instructions from the local, cyclic, queue until a predefined condition has occurred. This condition is typically that the previous instruction that was fetched from the queue has been completed so that the decoder is ready to receive a new instruction.

Although the local queue 730 and the instruction register 722 are shown in this document as separate entities, it would be possible to combine them to one unit. For example, the instruction register 722 could be integrated as the last element of the local queue.

The buffer manager 744 supervises the operation of the local buffer 730 and manages repetition of the instructions currently stored in the circular buffer, whereas the queue controller 732 manages the start/stop of instruction dispatch from the circular buffer queue 730.

The buffer manager 744 further manages the repetition register 746 and keeps track of how many repetitions that have been performed. When the number of repetitions specified in the repetition register 746 have been performed, a signal is sent to the vector controller 720 which then can be sent to the sent to program flow control 703 (not shown in FIG. 6) to indicate that the operation is complete.

When the number of repetitions requested has been performed, the behavior of the circular buffer 730 defaults back to queue functionality, storing the last issued instructions so that a new repeat instruction can be started.

FIG. 7 illustrates the working principle of the local queue according to an embodiment of the invention. The queue itself is represented by a horizontal line 901. A first vertical arrow symbolizes the writing pointer 903, which indicates the position of the queue in which a new instruction is currently being written. A corresponding horizontal arrow 905 indicates the direction in which the writing pointer is moving, towards the right in the drawing.

A second vertical arrow symbolizes the reading pointer 907, which indicates the position of the queue from which an instruction to be executed is currently being read. A corresponding horizontal arrow 909 indicates the direction in which the reading pointer is moving, in the same direction as the writing pointer 903. The distance between the writing pointer 903 and the reading pointer 907 is the current length of the queue, that is, the number of instructions presently in the queue.

In the example of FIG. 7 a sequence of instructions that are to be repeated a number of times has been written to the queue. The start of the sequence and the end of the sequence are indicated by a first 911 and a second 913 vertical line across the horizontal line 901. A backwards arrow 915 indicates that when the reading pointer 907 reaches the end of the sequence of commands indicated by the second vertical line 913, the reading pointer will loop back to the start of the sequence of commands indicated by the first vertical line 911. This will be repeated until the sequence of instructions has been executed the specified number of times.

Control logic (not shown) is arranged to keep track of the number of instructions in the sequence to be iterated, and their position in the queue. This includes, for example:
The position 911 of the start of the sequence of instructions that are to be repeated
The position 913 of the end of the sequence of instructions that are to be repeated
The number of times that the sequence of instructions are to be repeated

Instead of the start and the end of the sequence, the position of either the start or the end of the sequence may be stored together with the length of the sequence, that is, the number of instructions included in the sequence. When a reading pointer 907 or writing pointer 903 reaches the end of a queue it will move to the start of the queue and continue to read or write, respectively, from the start.

1. A vector execution unit for use in a digital signal processor having a processor core, a program memory arranged to hold instructions for a plurality of execution units, and a plurality of data memory units arranged to hold data to be used by the vector execution unit, said vector execution unit being arranged to execute instructions, including vector instructions that are to be performed on multiple data in the form of a vector, comprising an instruction register arranged to receive and store instructions, an instruction decoder arranged to decode instructions stored in the instruction register, and at least one data path controlled by the instruction decoder, said vector execution unit further comprising:
a vector controller to determine if an instruction is a vector instruction and, if it is, inform a count register arranged to hold the vector length, said vector controller being further arranged to control the execution of instructions, wherein said vector execution unit comprises:
a local queue arranged to receive at least a first and a second instruction from a program memory and to hold the second instruction in the local queue until a predefined condition is fulfilled,
the local queue being arranged to receive a sequence of instructions at a time from the program memory and to store the last N instructions, N being an integer,
wherein the vector controller comprises queue control means arranged to control the local queue in such a way as to repeat a sequence of M instructions stored in the local queue, M being an integer less than or equal to N, a number K of times.

2. A vector execution unit according to claim 1, wherein the vector control unit is arranged to receive an issue signal and control the execution of instructions based on this issue signal.

3. A vector execution unit according to claim 1, wherein said queue control means comprises
a buffer manager arranged to keep track of the M instructions that are to be repeated, and the number K of times an instruction should be repeated, M and K being integers,
a iteration control means arranged to monitor the repeated execution of a sequence of instructions to determine when the iteration of the execution should be stopped,
an instruction count register arranged to hold the number M of instructions that are to be repeated and their position in the queue.

4. A vector execution unit according to claim 3, wherein the buffer manager is arranged to retrieve the integer K from the control register file.

5. A vector execution unit according to claim 3, wherein the buffer manager is arranged to retrieve the integer K from the instruction word.

6. A vector execution unit according to claim 3, wherein the iteration control means is a counter arranged to keep track of the K iterations.

7. A digital signal processor comprising:
a processor core including an integer execution unit configured to execute integer instructions; and
at least a first and a second vector execution unit separate from and coupled to the processor core, wherein each vector execution unit is a vector execution unit according to any one of the preceding claims;
said digital signal processor comprising a program memory arranged to hold instructions for the first and second vector execution unit and issue logic for issuing instructions, including vector instructions, to the first and second vector execution unit.

8. A digital signal processor according to claim 7, wherein the program memory is also arranged to hold instructions for the integer execution unit.

9. A digital signal processor according to claim 7, wherein the program memory is arranged in the processor core.

10. A baseband communication device suitable for multimode wired and wireless communication, comprising:
a front-end unit configured to transmit and/or receive communication signals,
a programmable digital signal processor coupled to the analog front-end unit, wherein the programmable digital signal processor is a digital signal processor according to claim 1.

11. A baseband communication device according to claim 10, wherein the front-end unit is an analog front-end unit arranged to transmit and/or receive radio frequency or baseband signals.

12. A baseband communication device according to claim 11, said baseband communication device being arranged for communication in a cellular communications network.

13. A baseband communication device according to claim 10, said baseband communication device being a television receiver.

14. A baseband communication device according to claim 10, said baseband communication device being a cable modem.
